(19) United States
(12) Patent Application Publication
(10) Pub. No.: US 2016/0244237 A1
(43) Pub. Date: Aug. 25, 2016

(54) TWO COMPARTMENT CONTAINER AND METHOD FOR MAKING A TWO COMPONENT BEVERAGE

(71) Applicant: NESTEC S.A., Vevey (CH)

(72) Inventors: Stephane Hentzel, Yvonand (CH); Marc Montarras, Pully (CH)

(73) Assignee: NESTEC S.A., Vevey (CH)

(21) Appl. No.: 15/028,080

(22) PCT Filed: Oct. 9, 2014
(86) PCT No.: PCT/EP2014/071624

§ 371 Date: Apr. 8, 2016

(30) Foreign Application Priority Data
Oct. 10, 2013 (EP) 13188187.2

(51) Int. Cl. B65D 81/32; A23F 5/26; B65D 85/804; B65D 3/06; B65D 3/24

(52) U.S. Cl. CPC B65D 81/32; B65D 3/06; B65D 3/24; B65D 85/8043; A23F 5/262; B65D 2581/3409

(57) ABSTRACT

The invention concerns a two compartment container (10) for making a two component beverage comprising: —at least one upstanding external sidewall (12) defining an internal volume; —an internal separating wall (22) extending between the at least one sidewall (12) and separating the internal volume; and —a first (18) and second (20) lid each attached to an end portion (12a, 12b) of the upstanding sidewall (12); thereby defining a two compartment container comprising a first compartment (24a) bounded by sidewall (12), separating wall (22) and first lid (18) and a second compartment (24b) located on the opposite side of the first compartment (24a) and bounded by sidewall (12), separating wall (22) and second lid (20). The invention also relates to a method for making a two component beverage in a cup using the claimed two compartment container (10), the method comprising at least the following steps: —accessing a first compartment (24a) of the two compartment container (10) containing a first ingredient (32); —emptying the first ingredient (32) from the first compartment of the two compartments container (10) into the cup; —turning the two compartment container (10) upside down; —accessing the second compartment (24b) of the two compartment container (10) containing a second ingredient (34); and —emptying the second ingredient (34) from the second compartment (24b) of the two compartments container (10) into the cup.

### FIELD OF THE INVENTION

The invention relates to a two compartment container for making a two component beverage.

The invention also relates to a method for making a two component beverage using the claimed two compartment container.

### BACKGROUND

Certain coffee beverages are formed from combining two different ingredients in a specific order. For example, a “latte machiatto” beverage is prepared by adding coffee to a cup already containing foamy milk. In a cup of “latte machiatto”, the coffee is at the bottom of the cup and the foamy milk on the top of it.

As of today, one system for forming a two component beverage includes two packs of powdered beverage ingredient. One of the packs can include powdered milk, and the other instant coffee. The packs can each be separately combined with hot liquid to form different beverage components. The components can then be combined to form a two component beverage. However, the consumer has in hand two individual packs or two packs linked together generally side by side. This presentation is not appealing for the consumer and does not allow having a compact structure for making specific two component beverages.

Another possibility for forming a two component beverage is to use a capsule machine but it some circumstances, it is not possible to have access to this ultimate technology.

It is therefore an object of the present invention to provide a two compartment container and associated method for forming a two component beverage that solves the drawbacks of the prior art.

### SUMMARY OF THE INVENTION

In this respects, the invention provides a two compartment container according to claim 1 in which the two compartments are each provided on an end side of the container.

Due to the fact that the compartments are located on the two end sides of the container, the container is very compact and can be transported easily. It is also very aesthetic and attractive for the consumer.

Furthermore, it allows reducing the amount of packaging material versus a packaging having two individual pack linked together. This is especially the case when the container is developed as a single container and not as two containers linked together. As a characteristic of the present application, the compartments are formed using the two sides of the packaging material used for forming the container.

As proposed, the container comprises two compartments. The first compartment bounded by the container sidewall, an internal separating wall and a first lid of the container and the second compartment which is located on the opposite side of the first compartment is bounded by the sidewall, the internal separating wall and a second lid of the container.

As the container uses the two sides of a packaging wall material, the separating wall is integral with the container and is common to the two compartments.

According to a further feature, the sidewall has one peripheral flange located at one end of the sidewall for the first lid to be attached to the peripheral flange.

According to another feature, the sidewall comprises a leaky bottom wall at one end of the sidewall for the second lid to be attached to the bottom wall.

According to a further feature, the sidewall has first and second peripheral flange on its both ends and the first and second lids are respectively attached to the first and second peripheral flange. The presence of peripheral flanges makes it possible to position and seal the lids in a conventional and efficient way.

Optionally, first and/or second lid have a tab that is folded to overlay the remainder of the first and/or second lid, the tab being movable toward an unfolded position for gripping to facilitate removal of the first and/or second lid. This characteristic allows an easy removal of the lid and participates to the convenience of the claimed two compartment container.

In addition, the container may comprise means for handling the container. Said means can take the form of a handle or a grip portion extending from one of the peripheral flange of the sidewall or extending from the sidewall itself.

According to another further feature, the first and second ingredients contained in the two compartments of the two compartment container are different in order to make a two component beverage.

Additionally, the first and second ingredients can take the form of powered, syrup, concentrate liquid or solid ingredients or a mixture thereof.

Furthermore, to allow a variety of two components beverage to be made, the first and second ingredients are selected from the group containing coffee, cocoa, tea, milk, yogurt, sugar, sweeteners, bouillon, soup, vegetables, cereals, probiotics or a mixture thereof.

According to the invention a method is also provided for forming a two component beverage in a cup using a two compartment container, according to claim 11.

The proposed method allows making a two component beverage in a quick and easy way using a combination of elementary steps as:
accessing a first compartment of the two compartment container containing a first ingredient;
emptying the first ingredient from the first compartment of the two compartments container into the cup;
turning the two compartment container upside down;
accessing the second compartment of the two compartment container containing a second ingredient; and
emptying the second ingredient from the second compartment of the two compartments container into the cup.

It is to be noted that in addition to the proposed steps, further steps are proposed as removing a first compartment lid from the container for accessing the first ingredient from the first compartment of the two compartment container.

Similar step is also proposed for accessing to the second ingredient. So, for accessing the second ingredient from the second compartment of the two compartment container the method includes the step of first removing a second compartment lid from the container.

Furthermore, if the first ingredient is not liquid, in order to get a beverage product, the method also comprises the step of combining a liquid with the first ingredient in the cup to form a first beverage component.

As a proposal, the liquid combined with the first ingredient in the cup to form the first beverage component is hot water.

More particularly, before accessing to the second compartment, the method proposes blocking access to the first compartment of the two compartment container by closing the first compartment lid. This specific action allows avoiding particles or liquid drops to fall out from the first compartment when the container is turned upside down for accessing the second compartment.

### BRIEF DESCRIPTION OF THE DRAWINGS

The invention is further described with reference to the following examples. It will be appreciated that the invention as claimed is not intended to be limited in any way by these examples.

Embodiments of the present invention will now be described, by way of examples, with reference to the accompanying figures in which:

FIG. 1a is a perspective view of a first embodiment of a two compartment container of the invention containing ingredients for use in forming a two component beverage;

FIG. 1b is a section view of the container of FIG. 1 showing a first compartment and a second compartment, with a first lid covering the first compartment and a second lid covering the second compartment;

FIG. 1c is a section view of the container of FIG. 1b taken along line A-A thereof, and showing a first compartment and a second compartment, with a first lid covering the first compartment and a second lid covering the second compartment;

FIG. 1d is a view of the two compartment container from above in transparency;

FIG. 2a is a is perspective view of a second embodiment of a two compartment container of the invention containing ingredients for use in forming a two component beverage;

FIG. 2b is a section view of the container of FIG. 1 showing a first compartment and a second compartment, with a first lid covering the first compartment and a second lid covering the second compartment;

FIG. 2c is a section view of the container of FIG. 2b taken along line B-B thereof, and showing a first compartment and a second compartment, with a first lid covering the first compartment and a second lid covering the second compartment;

FIG. 3a is a section view of the container of FIG. 1 according to a third embodiment of a two compartment container of the invention showing a first compartment and a second compartment, with a first lid covering the first compartment and a second lid covering the second compartment;

FIG. 3b is a section view of the container of FIG. 3a taken along line C-C thereof, and showing a first compartment and a second compartment, with a first lid covering the first compartment and a second lid covering the second compartment; and

FIG. 4 is a section view, in transparency, of a two compartment container of the invention showing a first ingredient in a first compartment and a second ingredient in a second compartment, with a first lid covering the first compartment and a second lid covering the second compartment.

### DETAILED DESCRIPTION

As used in this specification, the words “comprises”, “comprising”, and similar words, are not to be interpreted in an exclusive or exhaustive sense. In other words, they are intended to mean including, but not limited to.

Any reference to prior art documents in this specification is not to be considered as an admission that such prior art is widely known or forms part of the common general knowledge in the field.

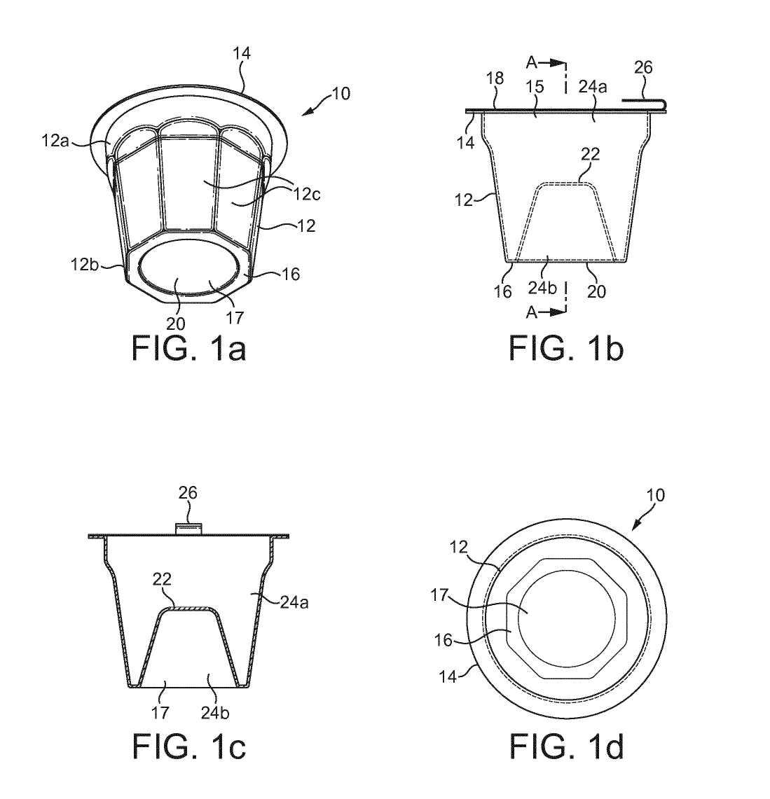

FIG. 1a is a perspective view of a first embodiment of a two compartment container 10 of the invention containing ingredients (not visible) for use in forming a two component beverage.

The two compartment container 10 includes an upstanding external sidewall 12 having two opposite ends: an upper end 12a and a lower end 12b. The sidewall 12 has a substantially octagonal circumference and defines an internal volume.

The container 10 also comprises a peripheral flange 14 at the upper end 12a of the sidewall 12 and a bottom wall 16 at the lower end 12b of the sidewall 12. The bottom wall 16 is leaky in its center to allow access to the internal volume defined by sidewall 12.

The container 10 is of thin-walled construction, such that the inner contour generally or substantially is the same as the outer contour.

In the present embodiment, the container 10 has a circular peripheral flange 14 at its upper end 12a and a bottom wall 16 having a generally octagonal external circumference. The sidewall 12 has a substantially octagonal circumference with vertical flared out panels 12c.

The peripheral flange 14 and the leaky bottom wall 16 each defines an opening 15, 17 giving access to the internal volume defined by sidewall 12.

The openings 15 and 17 respectively corresponding to the upper end 12a and lower end 12b of sidewall 12 are respectively closed by first lid 18 (not visible) and second lid 20. The first lid 18 is then attached to the peripheral flange 14 and the second lid 20 to the bottom wall 16.

As can be seen in FIGS. 1b and 1c, both figures presenting sections view of the two compartment container of FIG. 1a, the container 10 also comprises an internal separating wall 22 extending transversally between the sidewall 12 and separating the internal volume in two compartments: a first compartment 24a on the upper part of the container and a second compartment 24b on the lower part of the container.

The first compartment 24a is then bounded by the separating wall 22, the sidewall 12 and the first lid 18. Similarly, the second compartment 24b is bounded by the separating wall 22, the sidewall 12 and the second lid 20.

The container 10 thereby comprises two independent compartments that may respectively contain a first and a second ingredient. The first ingredient is stored in the first (upper) compartment 24a and the second ingredient is stored in the second (lower) compartment 24b.

In the present embodiment, due to the general shape of the container, the container has an upstanding preferred position which allows defining an upper and a lower compartment.

According to the two component beverage to be done, the first and second ingredients are different. The ingredient can also be of different form and consistency. For example, the ingredients can be in powdered, syrup, concentrate, liquid or even solid form. The ingredient can also be a mixture of several ingredients of different forms.

Ingredients are selected from the group consisting of coffee, cocoa, tea, milk, sugar, bouillon, soup, vegetable, cereals, probiotics or a mixture thereof.

For example, one ingredient to be stored in the compartment can also be a premix of two or several basic ingredients.

As can be seen in FIGS. 1a to 1c, the compartments 24a and 24b of container 10 do not have the same volume and the volume of the compartments vary with the shape of the internal separating wall. The volumes of the compartments are chosen according to the two component beverage to be done.

For example, for a “latte machiatto” beverage, the first compartment, which in the first embodiment is the bigger one, contains powdered milk and the second compartment contains coffee syrup. Hence for preparing a nice “latte machiatto”, the powdered milk is mixed in a cup with hot water to provide a cup of foamy milk and then the coffee syrup is poured in the cup. The coffee syrup goes down at the bottom of the cup, is warmed with the milk and leaves the foam of the milk white at the top of the beverage.

For example, for a cereal soup, the first compartment contains dry vegetable based soup and the second compartment contains cereals.

For specific infant nutritional composition, the first compartment contains powdered milk and the second compartment contains probiotics to be mixed with the milk once reconstituted.

Based on the above examples, one can see that many type of two component beverages may be made according to the consumer needs and wishes.

The upper and lower lids 18 and 20 can optionally be configured to facilitate removal.

As exemplified in FIGS. 1b and 1c, the upper lid 18 includes a tab 26 that is provided in a folded position overlying the remainder of the upper lid 18. The tab 26 can be unfolded to extend beyond the perimeter of the peripheral flange 14 to permit gripping of the tab 26. The tab 26 can then be used to pull the upper lid 18 from the flange 14.

The lower lid 20 can also include a tab but this embodiment has not been represented.

To finalize the description of this first embodiment, FIG. 1d represents an above view in transparency of externals walls the two compartment container. The shape of external wall at the different location on the container 10 is shown.

Hence, the circular peripheral flange 14, the sidewall 12, the octagonal circumference of the bottom wall 16 and the opening 17 can be seen.

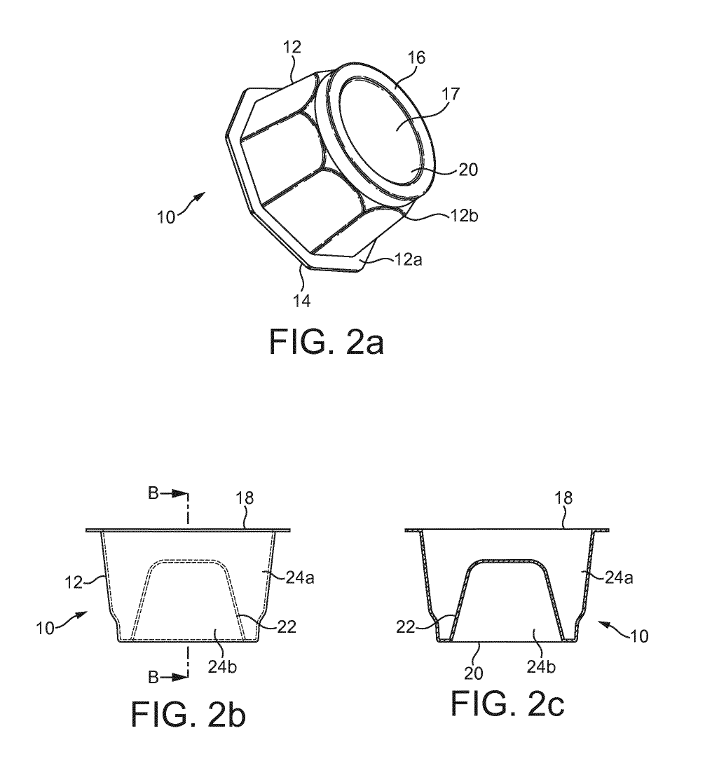

FIGS. 2a to 2c represent, with the same reference numbers used for like parts, the same construction of two compartment container 10 with the exception that the internal separating wall 22 has a different shape. This different shape leads to compartments 24a and 24b having different dimensions than the ones presented in the frame of the first embodiment (FIGS. 1a to 1d).

The perspective of the container 10 of FIG. 2a also shows an external shape of the container being a bit different from the one of the first embodiment.

Indeed, in this second embodiment, the container 10 has at its upper end 12a a peripheral flange 14 having a generally octagonal external circumference and at its lower end 12b a bottom wall 16 having external circular circumference. The sidewall 12 has a substantially octagonal circumference with vertical flared out panels 12c from the lower end 12b to the upper end 12a.

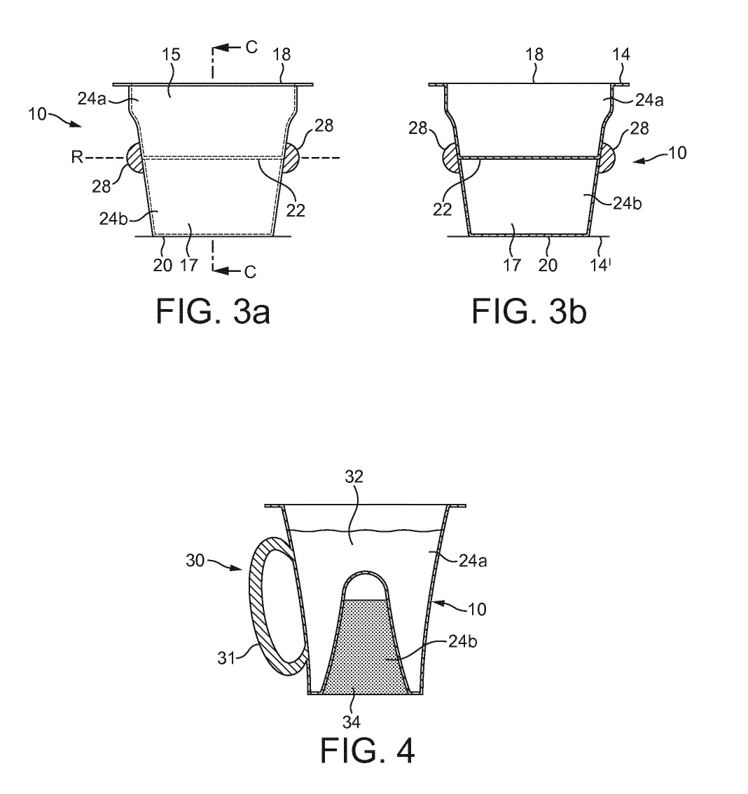

FIGS. 3a and 3b represent, with the same reference numbers used for like parts, side views of a third embodiment of the two compartment container 10. In this third embodiment, one can see another variant in the shape and geometry of the internal separating wall and a container having peripheral flange located at each opposite end of the sidewall 12. Hence, the container 10 comprises one peripheral flange 14 at one end of sidewall 12 and one peripheral flange 14′ at the other end of sidewall 12. Each compartment opening 15, 17 has a peripheral flange 14, 14′ for a lid to be attached.

While the peripheral flange 14 of the two compartment container 10 of FIGS. 1a to 2c can be used for handling, alternative configurations as presented in FIGS. 3a, 3b and 4 can be proposed for an easy handling.

FIGS. 3a, 3b proposes to have handling means formed by outwardly protruding projections 28 as support points for handling the container 10 between two fingers of one hand. The turning upside down of the container can be done by rotation of the container along a rotation axis R while still maintaining the container between two fingers. This is very convenient for the consumer as it allows easy manipulation of the container 10.

FIG. 4, with the same reference numbers used for like parts, proposes another option for handling of the container 10. In this exemplary embodiment of the two compartment container 10, the handling means are provided in the form of a handle 30. The handle can extend radially outward from the sidewall 12, and can have arcuate edges.

Optionally, the handle 30 can include an indentation 31 to facilitate gripping. The indentation can include texturing or the like for further facilitating gripping. The handle 30 can be generally planar, except for the optional indentation 31. The handle 30 and optional indentation 31 can be incorporated into any of the containers 10 described herein.

The height and circumference of the two compartment container can vary depending on the ingredient to be stored in the container and are adapted to provide an aesthetic appearance.

As mentioned above, the two compartment container 10 of the embodiments described herein is generally of thin-walled construction. The container 10 can be formed using thermoforming, injection molding or other suitable techniques. The material can be polypropylene-based, and can optionally have a barrier layer, although other materials, including other polymers, can also be suitable. Optionally, the material can be transparent or translucent in order to permit visual observation of the contents from the exterior of a sealed or partially sealed container.

In case the container is formed using plastic thermoforming technique, the two compartments are created on the two sides of the material so that the food/beverage materials will be in contact with the two sides of the packaging material. This is a real innovation and it allows saving packaging material versus a solution of two containers linked together.

Metal, aluminum, paper or laminated material can also be used with the same aim. In the end, the material will be chosen according to the required protection level for the ingredients.

Once the container is made, it should be filled on its both sides. As an example, one can first fill the smallest compartment and then the biggest one.

It should also be noted that aseptic filling or even pasteurization can be made if the preservation of the ingredient needs such processing.

The upper and lower lids 18 and 20 can be formed of foil laminates or other suitable materials. The lids can be rigid, and can be of any suitable configuration providing a barrier. The upper and lower lids 18 and 20 can optionally be suitable for heat or ultrasonic welding to the peripheral flange 14 and/or bottom wall 16, respectively, although other ways of sealing can be utilized, such as adhesives or the like.

Although the shape of the exemplary embodiments of the container is generally rounded or octagonal, the container 10 can have a major axis and a minor axis, both perpendicular to a longitudinal axis extending through the bottom wall 16 and the upper lid 14. The major axis can be greater than the minor axis such that the container 10 is oblong. When viewed from the top, the container 10 has a generally ovular appearance. However, other shapes of the container 4 can also be suitable.

As possible alternatives, the two compartment container can be square or rectangular.

The proposed invention also relates to a method for forming a two component beverage using a container 10 having two compartments, a first upper compartment 24a and a second lower compartment 24b, each containing a food or beverage ingredient.

As illustrated in FIG. 4, the first compartment 24a contains a first beverage ingredient 32, such as liquid milk, and the second compartment 24b contains a second beverage ingredient 34, such as instant coffee.

In the upstanding position of the container 10, the first (upper) compartment 24 is preferably stacked above the second (lower) compartment 24b, such that access to the second compartment 24b is through turning upside down the container 10.

The method includes accessing the first compartment 24a and transferring the first ingredient 32 into a cup (not represented) by emptying the first compartment 24a. The access is accomplished by removal of a first lid 18 covering the first compartment 24a, for example. Water or another aqueous medium is added to the first ingredient 32 into the cup in order to form a first beverage component.

The method also includes accessing the second compartment 24b, after turning the container 10 upside down.

The access can be accomplished by removal of a second lid 20 covering the second compartment 24b. The second ingredient is emptied in the cup containing the first beverage component to form a two component beverage.

Preferably, though not necessarily, the first compartment 24a after having been emptied is reclosed so that when turning the container upside down, no remaining ingredient in the first compartment falls down.

Stirring or other mixing, other than the pouring, can be used to make or combine the ingredients/beverage components.

In an exemplary form as presented in FIG. 4, the first ingredient 32 stored in the upper compartment 24a is liquid milk and the second ingredient 34 stored in the lower compartment 24b is instant coffee. The liquid for forming the first beverage components using the second ingredient first can be hot water. The resultant two component beverage is formed by adding the milk to the beverage component formed from the instant coffee.

In the example of FIG. 4, the ingredient stored in the lower compartment is first used and combine with aqueous medium and the ingredient stored in the upper compartment is then added to the first component beverage. For ease of understanding, along this description, names were given to the different elements and ingredients according to their arrangement but it is only a question of reference and given name.

However, as already mentioned other ingredients can be used and/or the relative positions of the ingredient in the compartment switched in order to form different two component beverages. Moreover, other components can be included to form a beverage having multiple components greater than two in number, for example by premixing several ingredients in a compartment.

Although the invention has been described by way of example, it should be appreciated that variations and modifications may be made without departing from the scope of the invention as defined in the claims. Furthermore, where known equivalents exist to specific features, such equivalents are incorporated as if specifically referred in this specification.

1. A two compartment container comprising:
at least one upstanding external sidewall defining an internal volume;
an internal separating wall extending between the at least one sidewall and separating the internal volume; and
a first and second lid each attached to an end portion of the upstanding sidewall;
thereby defining a two compartment container comprising a first compartment bounded by sidewall, separating wall and first lid and a second compartment located on the opposite side of the first compartment and bounded by sidewall, separating wall and second lid.

2. The container of claim 1, wherein the sidewall has a peripheral flange located at one end of the sidewall for the first lid to be attached to this peripheral flange.

3. The container of claim 1, wherein the at least one sidewall comprises a leaky bottom wall at one end of the sidewall for the second lid to be attached to this bottom wall.

4. The container of claim 1, wherein the at least one sidewall has a first and a second peripheral flange on its both ends and the first and second lids are respectively attached to the first and second peripheral flange.

5. The container of claim 1, wherein first and/or second lid have a tab R that is folded to overlay the remainder of the first and/or second lid, the tab being movable toward an unfolded position for gripping to facilitate removal of the first and/or second lid.

6. The container of claim 1, wherein a member for handling the container is provided.

7. The container of claim 1, wherein the first compartment comprises a first ingredient and the second compartment comprises a second ingredient.

8. The container of claim 7, wherein the first and second ingredients are different.

9. The container of claim 7, wherein the first and second ingredients are selected from the group consisting of powered, syrup, concentrate, liquid, solid ingredients and mixtures thereof.

10. The container of claim 7, wherein the first and second ingredients are selected from the group consisting of coffee, cocoa, tea, milk, sugar, bouillon, soup, vegetables, cereals, probiotics and mixtures thereof.

11. A method of forming a two component beverage in a cup, using a two compartment container comprising: at least one upstanding external sidewall defining an internal volume; an internal separating wall extending between the at least one sidewall and separating the internal volume; and a first and second lid each attached to an end portion of the upstanding sidewall, thereby defining a two compartment container comprising a first compartment bounded by sidewall, separating wall and first lid and a second compartment located on the opposite side of the first compartment and bounded by sidewall, separating wall and second lid, the method comprising at least the following steps:
accessing a first compartment of the two compartment container containing a first ingredient;
emptying the first ingredient from the first compartment of the two compartments container into the cup;
turning the two compartment container upside down;
accessing the second compartment of the two compartment container containing a second ingredient; and
emptying the second ingredient from the second compartment of the two compartments container into the cup.

12. The method of claim 11, wherein the step of accessing the first ingredient from the first compartment of the two compartment container includes the step of first removing a first compartment lid from the container.

13. The method of claim 11, wherein the step of accessing the second ingredient from the second compartment of the two compartment container includes the step of first removing a second compartment lid from the container.

14. The method of claim 11, comprising the step of combining a liquid with the first ingredient in the cup to form a first beverage component.

15. The method of claim 14, wherein the liquid combined with the first ingredient in the cup to form the first beverage component is hot water.

16. The method of claim 11, comprising the step of blocking access to the first compartment of the two compartment container by reclosing the first compartment lid.
